(19) United States
(12) Patent Application Publication
(10) Pub. No.: US 2025/0182429 A1
(43) Pub. Date: Jun. 5, 2025

(54) INFORMATION PROCESSING SYSTEM THAT ALLOWS USER TO VIEW VIRTUAL OBJECT WITHOUT FEELING UNCOMFORTABLE, CONTROL METHOD, AND STORAGE MEDIUM

(71) Applicant: CANON KABUSHIKI KAISHA, Tokyo (JP)

(72) Inventor: TAKASHI ICHIMIYA, Kanagawa (JP)

(21) Appl. No.: 18/954,768

(22) Filed: Nov. 21, 2024

(30) Foreign Application Priority Data
Nov. 30, 2023 (JP) 2023-202896

(51) Int. Cl. G06V 10/141; G02B 27/01; G06V 20/20

(52) U.S. Cl. CPC G06V 10/141; G02B 27/0172; G06V 20/20

(57) ABSTRACT

A mechanism that allows a user to view a virtual object without feeling uncomfortable is provided. An information processing system includes one or more processors and/or circuitry configured to execute a control processing that, based on lighting information of a virtual object displayed on a display device in a superimposed manner on a real space, performs control of a lighting environment in the real space, and execute an obtainment processing that obtains information about the virtual object used in display of the virtual object via a network. The lighting information of the virtual object is included in the information about the virtual object.

### BACKGROUND OF THE INVENTION

### Field of the Invention

The present invention relates to an information processing system, a control method, and a storage medium.

### Description of the Related Art

As a technology that fuses the real world and a virtual world in real time, a mixed reality (MR) technology and an augmented reality (AR) technology have been known. These technologies are technologies that seamlessly fuse a real space and a virtual space (virtual object(s)) created by a computer.

As a display device that allows a user to feel that a virtual object actually exists in a real space, there are a video see-through type head mounted type display device and an optical see-through type head mounted type display device. An example of the head mounted type display device is a head mounted display (an HMD) (for example, see Japanese Unexamined Patent Application Publication (Translation of PCT Application) No. 2018-514017). In the case of the video see-through type, for example, an image of a real space picked up by an image pickup apparatus (for example, a video camera) is displayed in real time. Furthermore, an image of a virtual object is superimposed and displayed on the image of the real space. In the case of the optical see-through type, for example, the head mounted type display device includes lenses similar to lenses of ordinary glasses, and an image of a virtual object is projected onto the lenses.

In a virtual reality (VR) system, since a virtual object is displayed in a virtual space that is unrelated to a real space and is in harmony with the virtual space, the user will not feel uncomfortable with the way the virtual object appears.

On the other hand, in an MR system or an AR system, the user views a virtual object arranged in a real space. A virtual object has a pre-assumed optimal environment in which the virtual object appears natural, and in the case that this pre-assumed optimal environment differs from a real-space environment that the user actually observes, the user will feel uncomfortable with the way the virtual object appears.

### SUMMARY OF THE INVENTION

The present invention provides a mechanism that allows a user to view a virtual object without feeling uncomfortable.

Accordingly, the present invention provides an information processing system comprising one or more processors and/or circuitry configured to execute a control processing that, based on lighting information of a virtual object displayed on a display device in a superimposed manner on a real space, performs control of a lighting environment in the real space, and execute an obtainment processing that obtains information about the virtual object used in display of the virtual object via a network. The lighting information of the virtual object is included in the information about the virtual object.

Accordingly, the present invention provides an information processing system comprising one or more processors and/or circuitry configured to execute a control processing that, based on lighting information of a virtual object displayed on a head mounted display (an HMD) in a superimposed manner on a real space, performs control of a lighting environment in the real space. The lighting information of the virtual object is information that has been updated based on a lighting environment of surroundings of another HMD that has been arranged in a different location from the HMD.

According to the present invention, the user is able to view the virtual object without feeling uncomfortable.

Further features of the present invention will become apparent from the following description of exemplary embodiments with reference to the attached drawings.

### BRIEF DESCRIPTION OF THE DRAWINGS

FIG. 1 is a diagram that shows an example of a functional configuration of an information processing system according to a first embodiment.

FIG. 2 is a hardware configuration diagram of a client apparatus shown in FIG. 1.

FIG. 3 is a flowchart that shows a control processing executed by the information processing system shown in FIG. 1.

FIGS. 4A, 4B, and 4C are diagrams for explaining the control of a lighting environment in S312 of FIG. 3.

FIG. 5 is a diagram that shows an example of a functional configuration of an information processing system according to a second embodiment.

FIG. 6 is a flowchart that shows a control processing executed by the information processing system shown in FIG. 5.

### DESCRIPTION OF THE EMBODIMENTS

The present invention will now be described in detail below with reference to the accompanying drawings showing embodiments thereof.

Hereinafter, preferred embodiments of the present invention will be described in detail with reference to the accompanying drawings. First, a first embodiment of the present invention will be described. In the first embodiment, an information processing system that has combined an HMD and a studio capable of controlling a lighting environment will be described. In addition, in the first embodiment, a configuration in which the HMD is externally connected to an information processing apparatus will be described as an example. In the first embodiment, the information processing apparatus is a client apparatus described below, for example, a controller or a personal computer (a PC).

It should be noted that the information processing apparatus may be built into the HMD. Therefore, the present invention is also applicable to an HMD, which is one kind of the head mounted type display device. In addition, the present invention is also applicable to other head mounted type display devices. For example, a handheld type display device that a user holds in his/her hand and wears (places against) his/her head is one kind of the head mounted type display device, and the present invention is also applicable to a handheld type display device. The handheld type display device is, for example, a smartphone or a tablet terminal. Smart glasses (augmented reality glasses (AR glasses)) are also one kind of the head mounted type display device, and the present invention is also applicable to smart glasses. In addition, the present invention is also applicable to a head mounted type display device in which a user views an image with both eyes, and to a head mounted type display device in which a user views an image with one eye. A smartphone attached to a head mounted adapter (for example, virtual reality goggles (VR goggles)) is one kind of the head mounted type display device. The present invention is also applicable to display devices other than the head mounted type display devices (for example, stationary type display devices).

The present invention is also applicable to both the video see-through type and the optical see-through type. In the case of the video see-through type, for example, an image of a real space (the outside world) picked up by an image pickup apparatus (for example, a video camera) is displayed in real time on a display surface (a display surface that does not transmit light from the real space). Furthermore, a graphic (for example, an image of a virtual object) is superimposed (composited) and displayed on the image of the real space. In this case, the user is not able to view the real space directly, but is able to indirectly view the real space by viewing the displayed image, or is able to view the graphic superimposed on the image of the real space. In the case of the optical see-through type, for example, a graphic (for example, an image of a virtual object) is displayed on a display surface (a display surface that transmits light from a real space (the outside world)). In this case, the user is able to view the real space (the outside world) directly through the display surface, or is able to view the graphic displayed on the display surface.

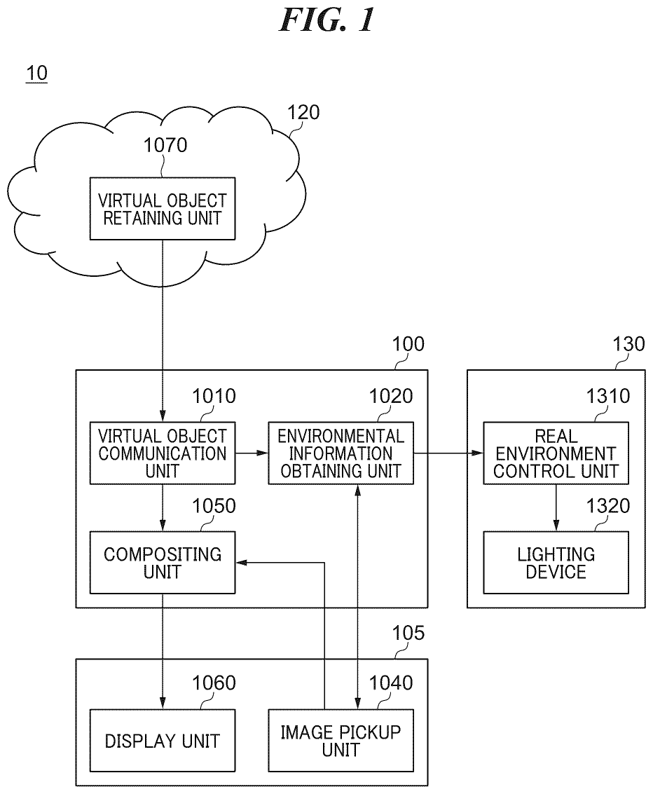

FIG. 1 is a diagram that shows an example of a functional configuration of an information processing system 10 according to the first embodiment. The information processing system 10 shown in FIG. 1 includes a server apparatus 120, a client apparatus 100, an HMD 105, and a studio 130. The HMD 105 is, for example, a video see-through type HMD. The client apparatus 100 is connected to the server apparatus 120 via a network, and the HMD 105 is connected to the client apparatus 100.

The client apparatus 100 is able to display an image of a real space on the HMD 105, and is also able to display an image of a virtual object by superimposing (compositing) the image of the virtual object with the image of the real space. A user of the client apparatus 100 (hereinafter, referred to as “a first user”) is able to perform a task (an operation) with respect to a virtual object while wearing the HMD 105 and viewing the virtual object.

The server apparatus 120 includes a virtual object retaining unit (a virtual object storage unit) 1070. The virtual object retaining unit 1070 retains virtual object information. The virtual object information is information relating to a virtual object, and includes, for example, information indicating a shape of the virtual object, information indicating an arrangement position of the virtual object, and information indicating a texture of the surface of the virtual object. In addition, the virtual object information includes an environment map, which is lighting information for the virtual object. The environment map includes a position of a virtual light source (a light source that illuminates the virtual object) that has been set for suitably viewing the virtual object, an intensity of the virtual light source, a color temperature of the virtual light source, and environmental information of the virtual object's surroundings. It should be noted that the virtual object information may further include image(s) obtained by photographing the virtual object's surroundings.

The HMD 105 includes an image pickup unit 1040 and a display unit 1060. The image pickup unit 1040 (an image obtaining unit) picks up image(s) of the surroundings of the HMD 105 in the studio 130. The surroundings of the HMD 105 may be considered as the surroundings of the client apparatus 100. The image pickup unit 1040 may be built into the HMD 105 or may be provided detachably and attachably with respect to the HMD 105. The image pickup unit 1040 is, for example, a video camera or a digital camera. It should be noted that the image pickup unit 1040 may be a stereo camera configured to pick up images in two directions, a direction close to a visual axis of the left eye and a direction close to a visual axis of the right eye. The display unit 1060 displays an image (a video image) based on image data (video image data) outputted from the client apparatus 100. The display unit 1060 is, for example, a small liquid crystal display or a small organic EL display. The image displayed on the display unit 1060 is enlarged by a lens provided in the HMD 105, and the first user wearing the HMD 105 views the image enlarged by this lens.

The client apparatus 100 includes a virtual object communication unit 1010, an environmental information obtaining unit 1020, and a compositing unit 1050.

The virtual object communication unit 1010 performs communication with the server apparatus 120 via the network. The communication performed by the virtual object communication unit 1010 is, for example, wired local area network communication (wired LAN communication), wireless LAN communication, Wi-Fi (registered trademark) communication, Bluetooth (registered trademark) communication, or infrared communication. The virtual object communication unit 1010 receives (obtains) the virtual object information from the virtual object retaining unit 1070 of the server apparatus 120 via the network. In the present embodiment, for example, in the case that the virtual object information has been updated in the client apparatus 100, the virtual object communication unit 1010 transmits the updated virtual object information to the virtual object retaining unit 1070 of the server apparatus 120 via the network. The virtual object information retained by the virtual object retaining unit 1070 is updated to the updated virtual object information that has been transmitted from the virtual object communication unit 1010.

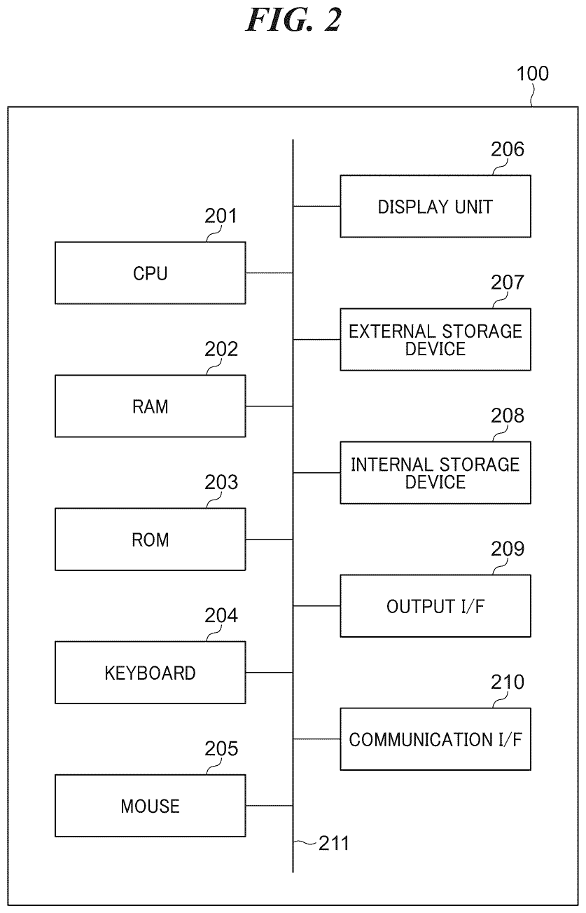

The environmental information obtaining unit 1020 obtains the environment map, which is the lighting information for the virtual object, from the virtual object information that has been obtained by the virtual object communication unit 1010. This environment map is transmitted to a real environment control unit 1310 in the studio 130 via a communication interface (a communication I/F) 210 shown in FIG. 2, which will be described below. Furthermore, the environmental information obtaining unit 1020 obtains real environment information. The real environment information is information about an environment of the surroundings of the client apparatus 100 in the studio 130. It should be noted that the method of obtaining the real environment information will be described in detail below.

The compositing unit 1050 obtains, from the image pickup unit 1040 of the HMD 105, an image of a real space that has been picked up the surroundings of the client apparatus 100 (image obtainment). The image of the real space is, for example, a moving image. In addition, the compositing unit 1050 generates a composite image based on the image of the real space that has been obtained and the virtual object information that has been obtained by the virtual object communication unit 1010, and controls the display unit 1060 to display this composite image. For example, the compositing unit 1050 generates a composite image by superimposing an image of a virtual object on the image of the real space, and outputs data of the composite image to the HMD 105.

In the studio 130, the real environment control unit 1310 and a lighting device 1320 have been arranged. The real environment control unit 1310 controls the lighting environment of the studio 130 based on the environment map included in the virtual object information that has been transmitted by the environmental information obtaining unit 1020. In the present embodiment, the real environment control unit 1310 controls the lighting device 1320 within the studio 130.

The lighting device 1320 is a device configured with a plurality of lights, and the luminance (the brightness), the color temperature, the light source's position, etc., of the lighting device 1320 are capable of being changed according to instructions from the real environment control unit 1310. It should be noted that in the present embodiment, it is assumed that the client apparatus 100 and the HMD 105 are used within the studio 130. The method of controlling the lighting device 1320 will be described in detail below.

It should be noted that in the present embodiment, a display device other than the HMD may be used. For example, an image of a real space may be picked up by a universal serial bus camera (a USB camera), and a composite image may be displayed on a display separate from the image pickup unit (the USB camera). Alternatively, an image of a real space may be picked up by a camera built into a laptop PC, and a composite image may be displayed on a display of the laptop PC. Alternatively, an image of a real space may be picked up by a camera built into a tablet PC, and a composite image may be displayed on a display of the tablet PC.

FIG. 2 is a hardware configuration diagram of the client apparatus 100 shown in FIG. 1. As shown in FIG. 2, the client apparatus 100 includes a central processing unit (a CPU) 201, a random access memory (a RAM) 202, a read only memory (a ROM) 203, a keyboard 204, a mouse 205, a display unit 206, an external storage device 207, an internal storage device 208, an output I/F 209, and the communication I/F 210. The CPU 201, the RAM 202, the ROM 203, the keyboard 204, the mouse 205, the display unit 206, the external storage device 207, the internal storage device 208, the output I/F 209, and the communication I/F 210 are connected to each other via a bus 211.

The CPU 201 controls each unit (each component) of the client apparatus 100. The ROM 203 stores various kinds of information in advance. For example, the ROM 203 stores operating system programs (OS programs), a device driver program, and programs of processing according to the first embodiment in advance. The RAM 202 temporarily stores various kinds of information. The CPU 201 loads the program that has been stored in the ROM 203 into the RAM 202 and executes it.

The keyboard 204 and the mouse 205 are an operation unit (an input interface (an input I/F)) that accepts operations (instructions) from the first user. The first user performs various kinds of operations (for example, tasks with respect to the virtual object) by using at least one of the keyboard 204 and the mouse 205. The keyboard 204 and the mouse 205 output operation signals in response to the operation (the instruction) from the first user, and the CPU 201 performs processing in response to the operation signals. It should be noted that the keyboard 204 and the mouse 205 may be configured to be detachable and attachable with respect to the client apparatus 100, or may be provided in the client apparatus 100.

The display unit 206 displays various kinds of images. It should be noted that the display unit 206 may be configured to be detachable and attachable with respect to the client apparatus 100, or may be provided in the client apparatus 100. The external storage device 207 is a storage device that stores various kinds of information, and is provided detachably and attachably with respect to the client apparatus 100. The internal storage device 208 is a storage device that stores various kinds of information, and is built into the client apparatus 100.

The output I/F 209 is used to output the image data to an external apparatus (for example, the HMD 105). The output I/F 209 may be usable to obtain information from an external apparatus. The communication I/F 210 is used to perform communication with an external apparatus (for example, the server apparatus 120 or the real environment control unit 1310).

The virtual object communication unit 1010, the environmental information obtaining unit 1020, and the compositing unit 1050 that are shown in FIG. 1 are realized (implemented) by the CPU 201. For example, as realized by the virtual object communication unit 1010, the CPU 201 performs communication with the server apparatus 120 via the communication I/F 210 (and the network). As realized by the compositing unit 1050, the CPU 201 obtains the image of the real space from the HMD 105 via the output I/F 209. Furthermore, the CPU 201 generates a composite image and outputs data of the composite image to the HMD 105 via the output I/F 209.

In addition, the CPU 201 also performs update of the virtual object information that has been received from the virtual object retaining unit 1070 of the server apparatus 120. For example, when the first user performs a task with respect to the virtual object and the state of the virtual object (for example, the shape of the virtual object, the arrangement position of the virtual object, or the texture of the surface of the virtual object) changes, the CPU 201 updates the virtual object information so as to reflect this.

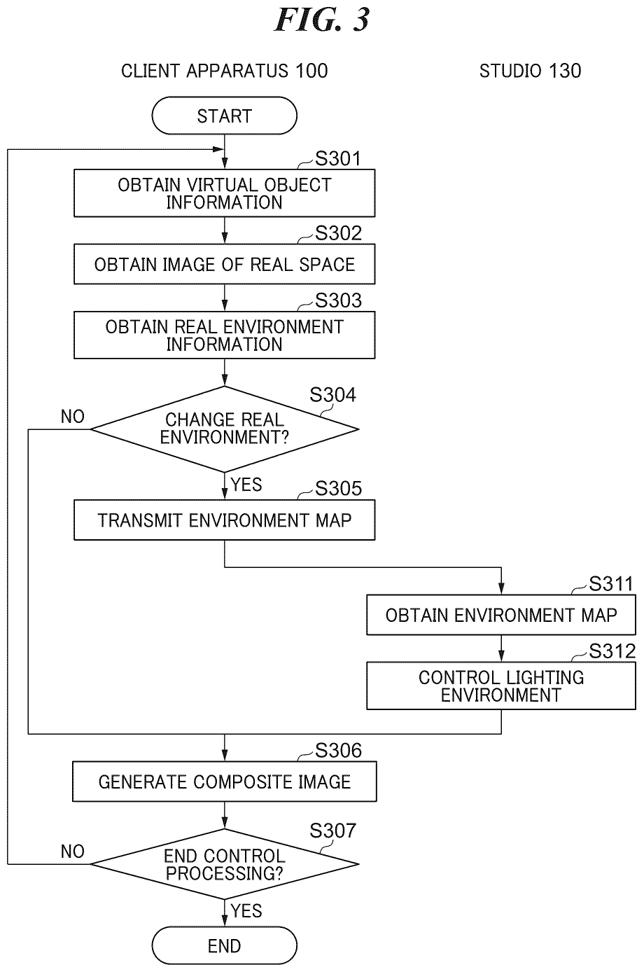

FIG. 3 is a flowchart that shows a control processing executed by the information processing system 10 shown in FIG. 1. It should be noted that in FIG. 3, processes of steps S301 to S307 are processes performed by the client apparatus 100, and are realized by the CPU 201 of the client apparatus 100 loading the program that has been stored in the ROM 203 into the RAM 202 and executing it. In addition, processes of steps S311 to S312 are processes in the studio 130, and are realized by a CPU (not shown) of the real environment control unit 1310 loading a program that has been stored in a ROM (not shown) into a RAM (not shown) and executing it. For example, when the first user performs an operation to display a virtual object with respect to the client apparatus 100 (issues an instruction to display a virtual object with respect to the client apparatus 100), the control processing shown in FIG. 3 is started.

As shown in FIG. 3, first, the CPU 201 of the client apparatus 100 receives the virtual object information from the server apparatus 120 via the network (S301). The CPU 201 obtains the environment map from the received virtual object information. It should be noted that as described above, the environment map is (includes) the position of the virtual light source that has been set for suitably viewing the virtual object, the intensity of the virtual light source, the color temperature of the virtual light source, and the environmental information of the virtual object's surroundings. It should be noted that for example, in the case that the environment map is not included in the virtual object information, the CPU 201 of the client apparatus 100 may create an environment map based on information such as the light-dark of the image of the virtual object and the direction of a shadow, which is based on the virtual object information. Other information other than the information described above may be added to the environment map that has been thus generated.

Next, the CPU 201 obtains, from the image pickup unit 1040 of the HMD 105, the image of the real space that has been picked up the surroundings of the client apparatus 100 (S302).

Next, the CPU 201 obtains the real environment information, which is the information about the environment of the surroundings of the client apparatus 100 in the studio 130 (S303). This real environment information includes, for example, any of the position of the light source in the environment of the surroundings of the client apparatus 100, the intensity of the light source, the color temperature of the light source, the brightness of the environment, exposure information of the image pickup unit 1040, and the image of the real space that has been obtained by the image pickup unit 1040.

For example, the position of the light source may be obtained (determined) based on the positions of high luminance areas in the image of the real space. The intensity of the light source may be obtained (determined) based on the luminance values of the high luminance areas in the image of the real space. The color temperature of the light source, the brightness of the environment, and the exposure information of the image pickup unit 1040 may be obtained from the image pickup unit 1040 as supplementary information together with the image of the real space. The color temperature of the light source may be obtained (determined) based on color information of the image of the real space (for example, the balance of R values, G values, and B values). The brightness of the environment may be obtained based on the luminance values of the entire image of the real space. The intensity of the light source and the brightness of the environment may each be obtained by using a light meter, or may be obtained (determined) based on lighting information of the studio 130 that has been obtained from the real environment control unit 1310. It should be noted that the real environment information obtained in S303 may be the information about the environment of the surroundings of the client apparatus 100, and is not limited to the information described above. In addition, the method of obtaining the real environment information is not particularly limited.

Next, the CPU 201 compares the environment map obtained in S301 with the real environment information obtained in S303, and determines whether or not it is necessary to change the real environment (S304). In S304, for example, in the case that the environment map and the real environment information match in predetermined items, it is determined that it is not necessary to change the real environment. In this case, the control processing shown in FIG. 3 proceeds to S306, which will be described below. It should be noted that the predetermined items are, for example, the position of the light source in the environment of the surroundings of the client apparatus 100, the intensity of the light source, and the color temperature of the light source. On the other hand, in the case that the environment map and the real environment information do not match in the predetermined items, it is determined that it is necessary to change the real environment. In this case, the control processing shown in FIG. 3 proceeds to S305.

In S305, the CPU 201 transmits the environment map to the real environment control unit 1310 via the communication I/F 210.

In the studio 130, when the real environment control unit 1310 obtains the environment map from the client apparatus 100 (S311), the real environment control unit 1310 controls the lighting environment within the studio 130 based on the obtained environment map (S312). It should be noted that the processing of controlling the lighting environment within the studio 130 will be described below. Once the lighting environment within the studio 130 has been controlled, the control processing shown in FIG. 3 proceeds to S306.

In S306, the CPU 201 generates a composite image by using the compositing unit 1050 to composite (superimpose) the image of the virtual object on the image of the real space obtained in S302. It should be noted that in generating the composite image, the compositing unit 1050 obtains the position and the attitude of the image pickup unit 1040, and renders the image of the virtual object so that the real space and the virtual object are geometrically consistent. The position and the attitude of the image pickup unit 1040 may be obtained (estimated) by any method. For example, simultaneous localization and mapping (SLAM), which detects feature points from a picked-up image (an image obtained by the image pickup unit 1040) and simultaneously estimates the self-position and a map of the feature points, may be used. Alternatively, a method, in which an index whose position in the real space is known is detected from a picked-up image, may be used. Alternatively, it is assumed that camera-specific parameters such as the focal length and the frustum are known, and when detecting feature points or an index from a picked-up image, the camera-specific parameters may be used to correct distortion in the picked-up image. Alternatively, an optical type sensor or a magnetic type sensor may be used, or an inertial measurement unit (an IMU) may be used. In the case of using the sensor, information on the positional relationship between the sensor and the image pickup unit 1040 is prepared in advance.

The compositing unit 1050 may obtain depth information of the real space (for example, a distance from the image pickup unit 1040). The method of obtaining the depth information is not particularly limited. Furthermore, the compositing unit 1050 may compare depth information of the virtual object (for example, a distance from a virtual camera) with the depth information of the real space, and generate a composite image so that the one in front among from a real object (an object in the real space) and the virtual object is displayed. By controlling in this way, it is possible to accurately represent the front/rear relation between the real object and the virtual object.

Next, the CPU 201 outputs data of the generated composite image to the HMD 105. The display unit 1060 of the HMD 105 displays the composite image based on the data of the composite image that has been outputted from the compositing unit 1050.

Next, the CPU 201 determines whether or not to end the control processing shown in FIG. 3 (S307). For example, in the case that the first user has performed an operation (has issued an instruction) to hide the virtual object (to end the display of the virtual object) with respect to the client apparatus 100, the CPU 201 determines to end the control processing shown in FIG. 3. In this case, the control processing shown in FIG. 3 ends. On the other hand, in the case that the operation to hide the virtual object (to end the display of the virtual object) has not been performed, the CPU 201 determines not to end the control processing shown in FIG. 3. In this case, the control processing shown in FIG. 3 returns to S301.

Here, the processing of controlling the lighting environment within the studio 130 in S312 will be described.

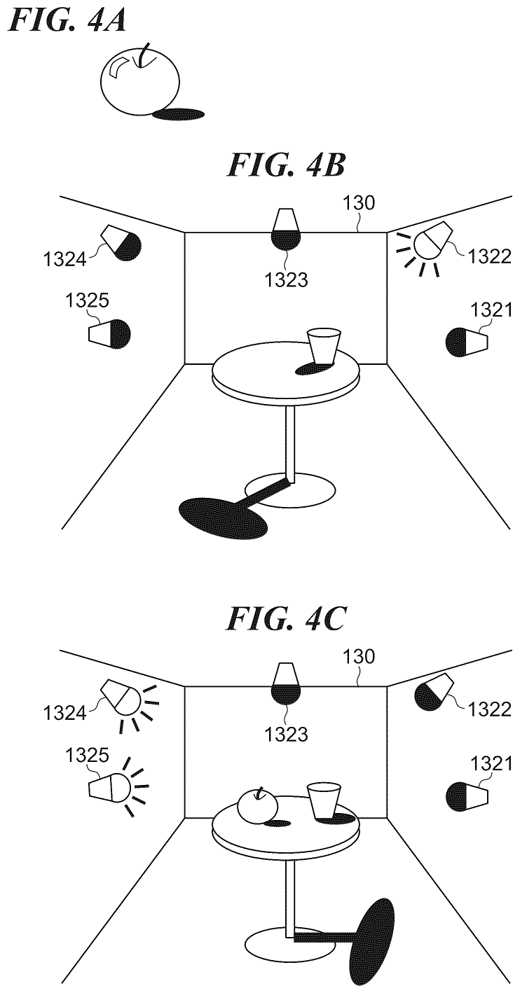

FIG. 4A is a diagram that shows a virtual object (an apple). As the environment map of this virtual object, information, which indicates that the virtual object is illuminated from the left direction by light from an incandescent light (the color temperature 3000K) with an illuminance of 1000 lx as viewed from the user's perspective, is attached.

FIG. 4B is a diagram that shows the state inside the studio 130 before the lighting environment is controlled. In the studio 130, five lights 1321 to 1325 are arranged as the lighting device 1320. The lights 1321 to 1325 are LED light sources of multiple colors, and the lighting intensity and the color temperature of each are capable of being controlled independently. In the studio 130, only the light 1322 is turned on, and regarding a table and a cup that are placed in the central portion of the studio 130, there are shadows to the left of the table and to the left of the cup. When the virtual object shown in FIG. 4A is superimposed on such a studio 130, the directions of the shadows of the real objects (that is, the directions of the shadows of the table and the cup that are placed in the central portion of the studio 130) will differ from the direction of the shadow of the virtual object, resulting in an unnatural composite image.

FIG. 4C is a diagram that shows the state inside the studio 130 after the lighting environment has been controlled. The real environment control unit 1310 controls the lighting environment within the studio 130 to turn off the light 1322 and turn on the lights 1324 and 1325, thereby being able to align the directions of the shadows of the table and the cup, which are the real objects, with the direction of the shadow of the apple, which is the virtual object. In addition, the real environment control unit 1310 is able to adjust the color temperature to 3000K and control the illuminance to 1000 lx, thereby matching the brightness of the lighting device 1320 in the studio 130 with the brightness of the virtual light source. In this way, it becomes possible to reproduce a natural composite image.

It should be noted that, in FIG. 4B and FIG. 4C, light bulb light sources (incandescent light sources) are used as the lighting device 1320 within the studio 130, but a two-dimensional display device such as an LED monitor may be used on the wall of the studio 130. In such a configuration, by displaying the image obtained by photographing the virtual object's surroundings, which has been stored as the environment map, on the two-dimensional display device, it is possible to obtain the same effect as that shown in FIG. 4C.

According to the above-described embodiment, the control of the lighting environment in the studio 130 (in the real space) is performed based on the environment map, which is the lighting information for the virtual object. As a result, it is possible to adjust the lighting environment of the studio 130 so that the virtual object is in harmony, allowing the user to view the virtual object without feeling uncomfortable.

In addition, in the above-described embodiment, the environment map includes at least any one of the position of the light source that illuminates the virtual object, the intensity of the light source, and the color temperature of the light source (that is, the environment map includes at least any one piece of information from among the position of the light source that illuminates the virtual object, the intensity of the light source, and the color temperature of the light source). As a result, it is possible to adjust to the lighting environment of the studio 130 (the real space) that allows the user to view the virtual object without feeling uncomfortable.

In addition, in the above-described embodiment, since the environment map is included in the virtual object information used to display the virtual object, it is possible to display the virtual object that is in harmony with the real space based on the obtained virtual object information.

In addition, in the above-described embodiment, the environment map is generated based on the image of the virtual object. As a result, even in the case that the environment map is not included in the virtual object information, it is possible to display the virtual object that is in harmony with the real space.

In addition, in the above-described embodiment, the control for changing the lighting environment in the studio 130 to a lighting environment corresponding to the environment map is performed. As a result, it is possible to align the lighting environment of the studio 130 with the lighting environment of the virtual object that has been set for suitably viewing the virtual object.

It should be noted that in the above-described first embodiment, the example has been described in which the lighting environment of the studio 130 is controlled in the case that the environment map in the virtual object information and the real environment information do not match in the predetermined items. However, in the case that the difference between the environment map in the virtual object information and the real environment information is relatively small with respect to the intensity of the light source and the color temperature of the light source, by changing exposure conditions and a white balance of the image pickup unit 1040, it is possible to suppress the sense of incongruity of the virtual object in the real space. Therefore, in the present embodiment, the control of the lighting environment of the studio 130 performed by the real environment control unit 1310 and exposure control of the image pickup unit 1040 that controls the exposure and development parameters of the image pickup unit 1040 may be performed in combination. As a result, it is possible to suppress the sense of incongruity of the virtual object in the real space.

However, in areas where the image of the real space picked up by the image pickup unit 1040 is blocked up with black, when a shutter time, which is one of the exposure conditions, is set long, image blurring will occur. Furthermore, increasing an ISO sensitivity will result in noise in the image. In such a case, it is effective to perform the control of the lighting environment of the studio 130 that has been described in the first embodiment, without performing the exposure control of the image pickup unit 1040. In addition, a configuration that switches between the exposure control of the image pickup unit 1040 and the control of the lighting environment of the studio 130 and performs the switched one may be used.

Next, a second embodiment of the present invention will be described. It should be noted that in the following, the descriptions of the same points as in the first embodiment (for example, the same configurations and the same processes as in the first embodiment) will be omitted, and differences from the first embodiment will be described.

In the first embodiment, the example has been described in which one client apparatus renders the image of the virtual object. In the second embodiment, a system in which a plurality of users wearing different HMDs share a virtual object will be described.

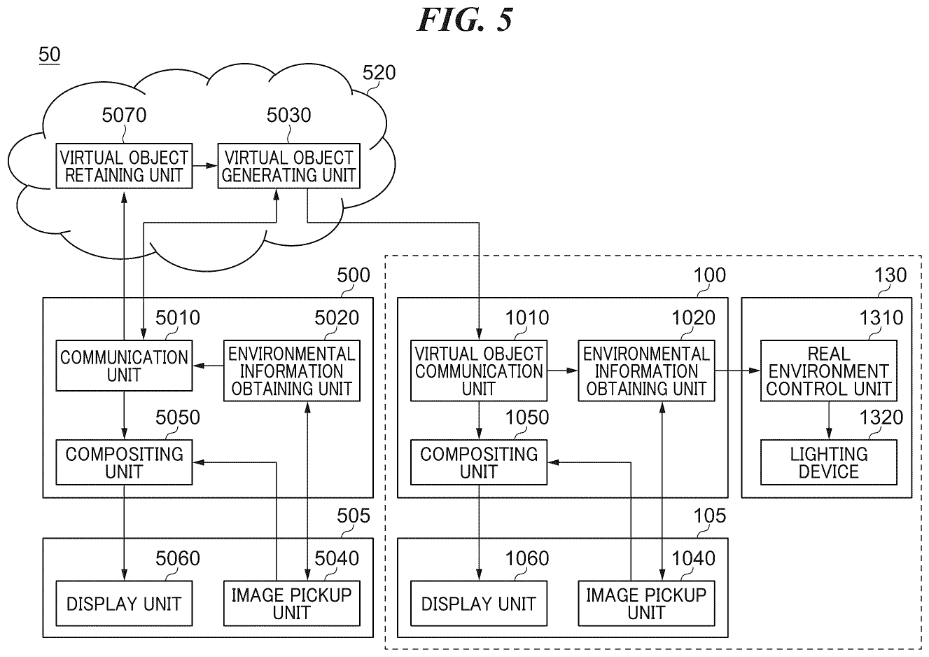

FIG. 5 is a diagram that shows an example of a functional configuration of an information processing system 50 according to the second embodiment. The information processing system 50 shown in FIG. 5 includes a server apparatus 520, the client apparatus 100, the HMD 105, the studio 130, a client apparatus 500, and an HMD 505.

The server apparatus 520 includes a virtual object retaining unit 5070 and a virtual object generating unit 5030. The virtual object retaining unit 5070 has the same functions as the virtual object retaining unit 1070 of the first embodiment. The virtual object generating unit 5030 receives real environment information from a client apparatus via the network. When receiving the real environment information from the client apparatus, the virtual object generating unit 5030 also receives an ID (identification information) of the client apparatus, and retains the real environment information and the ID in association with each other. The virtual object generating unit 5030 generates an image of a virtual object based on virtual object information that has been retained by the virtual object retaining unit 5070 and the real environment information that has been received from the client apparatus. Furthermore, the virtual object generating unit 5030 transmits the image of the virtual object that has been generated to the client apparatus via the network. The client apparatus, to which the image of the virtual object is transmitted, is the client apparatus having the ID linked to (associated with) the real environment information that has been used to generate the image of the virtual object.

The client apparatus 500 includes a communication unit 5010, an environmental information obtaining unit 5020, and a compositing unit 5050. The environmental information obtaining unit 5020 has the same functions as the environmental information obtaining unit 1020 of the first embodiment, and the compositing unit 5050 has the same functions as the compositing unit 1050 of the first embodiment. Similar to the virtual object communication unit 1010 of the first embodiment, the communication unit 5010 performs communication with the server apparatus 520 via the network. The communication unit 5010 transmits the real environment information obtained by the environmental information obtaining unit 5020 and an ID of the client apparatus 500 to the virtual object generating unit 5030 of the server apparatus 520 via the network. In addition, when a user of the client apparatus 500 (hereinafter, referred to as “a second user”) performs a task with respect to the virtual object and the state of the virtual object changes, the communication unit 5010 transmits information indicating the changed state (at least a part of the virtual object information) to the server apparatus 520 via the network. The virtual object information retained by the virtual object retaining unit 5070 of the server apparatus 520 is updated based on the information that has been transmitted from the communication unit 5010.

The client apparatus 100, the HMD 105, and the studio 130 have the same configurations as in the first embodiment.

It is assumed that the client apparatus 500 and the HMD 505 are used in a space separate from the studio 130.

In addition, a hardware configuration of the client apparatus 500 is the same as the hardware configuration of the client apparatus 100 shown in FIG. 1, which has been described. In the following description, the components of the client apparatus 500 will be indicated with “ ” added to the end of the components of the client apparatus 100.

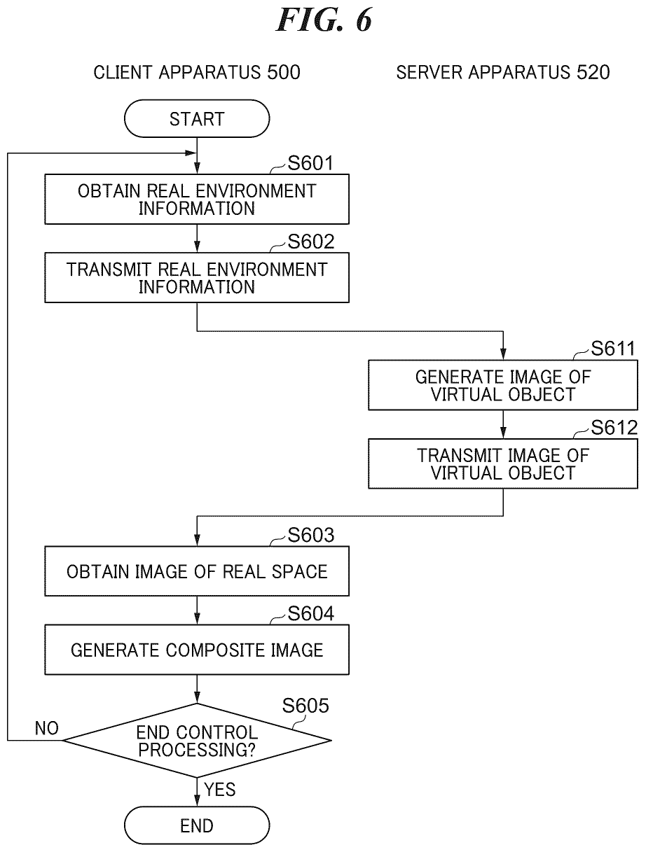

FIG. 6 is a flowchart that shows a control processing executed by the information processing system 50 shown in FIG. 5. It should be noted that in FIG. 6, processes of steps S601 to S605 are processes performed by the client apparatus 500, and are realized by a CPU 201′ of the client apparatus 500 loading a program that has been stored in a ROM 203′ into a RAM 202′ and executing it. In addition, processes of steps S611 to S612 are processes performed by the server apparatus 520, and are realized by a CPU (not shown) within the server apparatus 520 loading a program that has been stored in a ROM (not shown) into a RAM (not shown) and executing it. For example, when the second user performs an operation to display a virtual object with respect to the client apparatus 500 (issues an instruction to display a virtual object with respect to the client apparatus 500), the control processing shown in FIG. 6 is started.

As shown in FIG. 6, first, the CPU 201′ obtains real environment information about an environment of the surroundings of the client apparatus 500 (a real space) (S601). Next, the CPU 201′ transmits, to the server apparatus 520 via the network, the real environment information and the ID of the client apparatus 500 that have been obtained in S601 through the communication unit 5010 (S602).

In the server apparatus 520, the virtual object generating unit 5030 generates an image of a virtual object based on the virtual object information that has been retained by the virtual object retaining unit 5070 and the real environment information that has been transmitted from the client apparatus 500 in S602 (S611). The virtual object information that has been retained by the virtual object retaining unit 5070 is, for example, virtual object information generated or updated by the client apparatus 500. The virtual object generating unit 5030 performs the adjustment (the update) of the virtual object information based on the real environment information. For example, the virtual object generating unit 5030 changes the position of the light source, the intensity of the light source, and the color temperature of the light source of the environment map in the virtual object information to the position of the light source, the intensity of the light source, and the color temperature of the light source of the real environment information so that the virtual object is in harmony with a studio in which the client apparatus 500 has been arranged. The image of the virtual object is generated by performing rendering based on the adjusted virtual object information.

Next, the virtual object generating unit 5030 transmits the image of the virtual object that has been generated in S611 via the network to the communication unit 5010 of the client apparatus 500 corresponding to the ID that has been transmitted from the client apparatus 500 in S602 (S612).

In the client apparatus 500 that has received the image of the virtual object, the CPU 201′ obtains, from an image pickup unit 5040 of the HMD 505, an image of the real space that has been picked up the surroundings of the client apparatus 500 (S603).

Next, the CPU 201′ generates a composite image by using the compositing unit 5050 to composite (superimpose) the image of the virtual object that has been transmitted from the server apparatus 520 in S612 on the image of the real space obtained in S603 (S604). The compositing unit 5050 outputs data of the generated composite image to the HMD 505. A display unit 5060 of the HMD 505 displays the composite image based on the data of the composite image that has been outputted from the compositing unit 5050.

Next, the CPU 201′ determines whether or not to end the control processing shown in FIG. 6 (S605). It should be noted that the determination method in S605 is the same as the determination method in S307 described above. In the case that the CPU 201′ determines not to end the control processing shown in FIG. 6, the control processing shown in FIG. 6 returns to 601. On the other hand, in the case that the CPU 201′ determines to end the control processing shown in FIG. 6, the control processing shown in FIG. 6 ends.

It should be noted that processes performed by the client apparatus 100 and processes in the studio 130 are the same as the control processing shown in FIG. 3. However, the virtual object information to be received by the virtual object communication unit 1010 has been adjusted (updated) in S611 based on the real environment information corresponding to the environment of the surroundings of the client apparatus 500.

Therefore, by executing the control processing shown in FIG. 3, in the studio 130 in which the client apparatus 100 has been arranged, the lighting environment of the studio in which the client apparatus 500 has been arranged (the real space) is reproduced.

As described above, in the second embodiment, when the client apparatus 500 generates an image of a virtual object, the environment of the surroundings of the client apparatus 500 is taken into consideration. As a result, it is possible to obtain the same effects as those of the first embodiment. In addition, when the image of the virtual object is generated (rendered) by the server apparatus 520, the environment map is updated based on the real environment information corresponding to the environment of the surroundings of the client apparatus 500. The virtual object information including the updated environment map is transmitted to the client apparatus 100 via the server apparatus 520. This allows the plurality of users in different locations to view the virtual object suitably (in an environment equivalent to an environment of the surroundings of a specific client apparatus). In this way, the plurality of users is able to view the virtual object without feeling uncomfortable.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-202896, filed on Nov. 30, 2023, which is hereby incorporated by reference herein in its entirety.

What is claimed is:

1. An information processing system comprising one or more processors and/or circuitry configured to:
execute a control processing that, based on lighting information of a virtual object displayed on a display device in a superimposed manner on a real space, performs control of a lighting environment in the real space; and
execute an obtainment processing that obtains information about the virtual object used in display of the virtual object via a network, and
wherein the lighting information of the virtual object is included in the information about the virtual object.

2. The information processing system according to claim 1, wherein
the lighting information of the virtual object includes at least any one piece of information from among a position of a light source that illuminates the virtual object, an intensity of the light source, and a color temperature of the light source.

3. The information processing system according to claim 1, wherein
in the control processing, control for changing the lighting environment in the real space to a lighting environment corresponding to the lighting information of the virtual object is performed.

4. The information processing system according to claim 1, further comprising:
an image obtaining unit configured to photograph the real space, and
wherein the display device displays a composite image, in which an image of the virtual object is superimposed on an image of the real space that has been obtained by photographing the real space.

5. The information processing system according to claim 4, wherein
both exposure control of the image obtaining unit and the control of the lighting environment in the real space are performed.

6. An information processing system comprising one or more processors and/or circuitry configured to:
execute a control processing that, based on lighting information of a virtual object displayed on a head mounted display (an HMD) in a superimposed manner on a real space, performs control of a lighting environment in the real space, and
wherein the lighting information of the virtual object is information that has been updated based on a lighting environment of surroundings of another HMD that has been arranged in a different location from the HMD.

7. The information processing system according to claim 6, wherein
in the control processing, control for changing the lighting environment in the real space to a lighting environment corresponding to the lighting information of the virtual object is performed.

8. The information processing system according to claim 6, further comprising:
an image obtaining unit configured to photograph the real space, and
wherein the display device displays a composite image, in which an image of the virtual object is superimposed on an image of the real space that has been obtained by photographing the real space.

9. The information processing system according to claim 8, wherein
both exposure control of the image obtaining unit and the control of the lighting environment in the real space are performed.

10. A control method comprising:
a step of, based on lighting information of a virtual object displayed on a display device in a superimposed manner on a real space, performing control of a lighting environment in the real space; and
a step of obtaining information about the virtual object used in display of the virtual object via a network, and
wherein the lighting information of the virtual object is included in the information about the virtual object.

11. A non-transitory computer-readable storage medium storing a program for causing a computer to execute a control method,
the control method comprising:
a step of, based on lighting information of a virtual object displayed on a display device in a superimposed manner on a real space, performing control of a lighting environment in the real space; and
a step of obtaining information about the virtual object used in display of the virtual object via a network, and
wherein the lighting information of the virtual object is included in the information about the virtual object.
